(19) United States
(12) Patent Application Publication
(10) Pub. No.: US 2014/0122227 A1
(43) Pub. Date: May 1, 2014

(54) TARGETING MARKETING MESSAGES BASED ON USER PREFERENCES

(71) Applicant: MICROSOFT CORPORATION, REDMOND, WA (US)

(72) Inventor: DIRK HANS REINSHAGEN, BELLEVUE, WA (US)

(73) Assignee: MICROSOFT CORPORATION, REDMOND, WA (US)

(21) Appl. No.: 13/660,472

(22) Filed: Oct. 25, 2012

(51) Int. Cl. G06Q 30/02

(52) U.S. Cl. 705/14.53

(57) ABSTRACT

Methods, computer systems, and computer-storage medium for generating an advertisement-targeting profile based on learned user preferences are provided. An indication that a user is interacting with marketing messages on one or more Web pages is received. Each marketing message comprises a plurality of attributes. A set of attributes that is shared across the marketing messages is determined; the set of attributes comprises, in part, a subset of incentives. An advertisement-targeting profile comprising user preferences related to the set of attributes is generated. The advertisement-targeting profile is used, in part, to generate predefined marketing-message elements that may be used to modify marketing messages to increase user responsiveness to the messages.

### BACKGROUND

Targeting online advertisements or marketing messages to individual users or user groups in an effort to increase user responsiveness is becoming increasingly popular. Current targeting strategies focus on determining a location of a user and delivering advertisements related to the location. Another targeting strategy includes classifying a user into a demographic group and delivering advertisements targeted to that group. Yet another targeting strategy classifies users into one or more behavioral targeting segments and delivers advertisements geared to those segments. Users are classified into behavioral targeting segments based generally on Web pages visited and how long the user spends on any one Web page. For instance, a user who visits a variety of Web pages directed to automobiles may be classified into an auto-buyer behavioral targeting segment. Advertisements selected for display using behavioral targeting generally represent generic advertisements based mainly on a user's navigation history. This type of targeting strategy fails to take into account the more granular preferences of the user. For instance, a user that is interested in long-distance running may be conducting a search for the Olympics in London. Using behavioral targeting, the user may be improperly classified as belonging to a travel behavioral targeting segment and be presented with generic advertisements relating to travel, London or the Olympics, but would likely not be presented with more targeted and appropriate advertising relating to cross-country running shoes.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Aspects of the present invention relate to systems, methods, and computer-readable media for, among other things, creating an advertisement-targeting profile and using the profile, in part, to select online marketing messages (e.g., advertisements) and to generate predefined marketing-message elements. The predefined marketing-message elements may be inserted into template marketing messages to create marketing messages that appeal to the preferences of a user. The advertisement-targeting profile is created or updated by monitoring user interactions across a wide range of marketing messages on Web pages. The marketing messages are associated with attributes such as the product or service being advertised, qualities associated with the product or service (e.g., cost, ratings, brand name, etc.), and incentives associated with the product or service (e.g., shipping deals, sales offers, promotions, rewards points, etc.). Attributes that are shared across multiple marketing messages are determined, and these shared attributes are used to construct or update an advertisement-targeting profile for a user or group of users. For example, a user may consistently interact with marketing messages that have some type of shipping incentive (e.g., “free shipping,” “next day shipping,” and the like). The advertisement-targeting profile for the user indicates that the user has a preference for shipping incentives.

The advertisement-targeting profile, in one aspect, may be used to select for presentation on Web pages marketing messages that target the preferences of the user. Using the example given above regarding the user who has a preference for marketing messages with shipping incentives, a marketing message may be selected that includes, for example, free shipping. In another aspect, the advertisement-targeting profile may be used to generate predefined marketing-message elements directed towards the user's preferences. Again, using the above example, predefined marketing-message elements associated with the user may include “Free Shipping,” or “Next-Day Shipping.” These predefined marketing-message elements may be dynamically inserted into template marketing messages and presented on a Web page. For instance, the predefined marketing-message element “Free Shipping” may be inserted into a template marketing message directed towards a household appliance. Tailoring marketing messages based on user preferences helps to increase user responsiveness to these messages.

Accordingly, in one aspect, the present invention is directed to one or more computer-storage media storing computer-useable instructions that, when used by one or more computing devices, cause the one or more computing devices to perform a method of generating an advertisement-targeting profile useful for increasing user responsiveness to marketing messages. The method comprises receiving an indication that a user is interacting with a marketing message on one or more Web pages; the marketing message comprising a plurality of attributes. Using the one or more computing devices, a set of attributes of the plurality of attributes that is shared across a plurality of marketing messages is determined. The set of attributes comprises, in part, a subset of incentives. An advertisement-targeting profile for the user is updated based on the set of attributes. The advertisement-targeting profile comprises one or more user preferences related to the set of attributes.

In another aspect, the present invention is directed to a computerized method carried out by an advertisement server for modifying a marketing message using predefined marketing-message elements. The method comprises receiving a request from an advertiser or third party to present a marketing message on one or more Web pages. A data store that stores one or more predefined marketing-message elements that were generated using an advertisement-targeting profile associated with a user is accessed. At least one predefined marketing-message element is extracted, and the marketing message is modified using the at least one predefined marketing-message element. The modified marketing message is presented on the one or more Web pages.

In yet another aspect, the present invention is directed to a system for modifying one or more marketing messages using an advertisement-targeting profile. The system comprises a data store that stores a set of predefined marketing-message elements. Each predefined marketing-message element is associated with an identified user preference in an advertisement-targeting profile stored in association with the data store. The system further comprises an advertisement server, having one or more computer-storage media, coupled with the data store. The advertisement server receives a request from an advertiser or third party to present a marketing message on a Web page, accesses the set of predefined marketing-message elements stored in association with the data store, extracts at least one predefined marketing-message element from the set of predefined marketing-message elements, and modifies the marketing message using the at least one predefined marketing-message element.

### BRIEF DESCRIPTION OF THE DRAWINGS

The present invention is described in detail below with reference to the attached drawings figures, wherein:

FIG. 1 is a block diagram of an exemplary computing environment suitable for use in implementing embodiments of the present invention;

FIG. 2 is a block diagram of an exemplary system for generating an advertisement-targeting profile, generating predefined marketing-message elements, and modifying marketing messages based on the advertisement-targeting profile or the predefined marketing-message elements suitable for use in implementing embodiments of the present invention;

FIG. 3 is a diagram depicting a relationship between an advertisement-targeting profile and predefined marketing-message elements and their use in modifying a marketing message in accordance with an embodiment of the present invention;

FIG. 4 is a flow diagram that illustrates an exemplary method of generating an advertisement-targeting profile useful for increasing user responsiveness to marketing messages in accordance with an embodiment of the present invention; and

FIG. 5 is a flow diagram that illustrates an exemplary method of modifying a marketing message using predefined marketing-message elements in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Aspects of the present invention relate to systems, methods, and computer-readable media for, among other things creating an advertisement-targeting profile and using the profile to select online marketing messages (e.g., advertisements) and to generate predefined marketing-message elements. The predefined marketing-message elements may be inserted into template marketing messages to create marketing messages that appeal to the preferences of a user. The advertisement-targeting profile is created by monitoring user interactions across a wide range of marketing messages on Web pages. The marketing messages are associated with attributes such as the product or service being advertised, qualities associated with the product or service (e.g., cost, ratings, brand name, etc.), and incentives associated with the product or service (e.g., shipping deals, sales offers, promotions, rewards points, etc.). Attributes that are shared across multiple marketing messages are determined, and these shared attributes are used to construct and/or update an advertisement-targeting profile for a user or group of users. For example, a user may consistently interact with marketing messages that have some type of shipping incentive (e.g., “free shipping,” “next day shipping,” and the like). The advertisement-targeting profile for the user indicates that the user has a preference for shipping incentives.

The advertisement-targeting profile, in one aspect, may be used to select for presentation on Web pages marketing messages that target the preferences of the user. Using the example given above regarding the user who has a preference for marketing messages with shipping incentives, a marketing message may be selected that includes, for example, free shipping. In another aspect, the advertisement-targeting profile may be used to generate predefined marketing-message elements directed towards the user's preferences. Again, using the above example, predefined marketing-message elements associated with the user may include “Free Shipping,” or “Next-Day Shipping.” These predefined marketing-message elements may be dynamically inserted into template marketing messages and presented on a Web page. For instance, the predefined marketing-message element “Free Shipping” may be inserted into a template marketing message directed towards a household appliance. Tailoring marketing messages based on user preferences helps to increase user responsiveness to these messages.

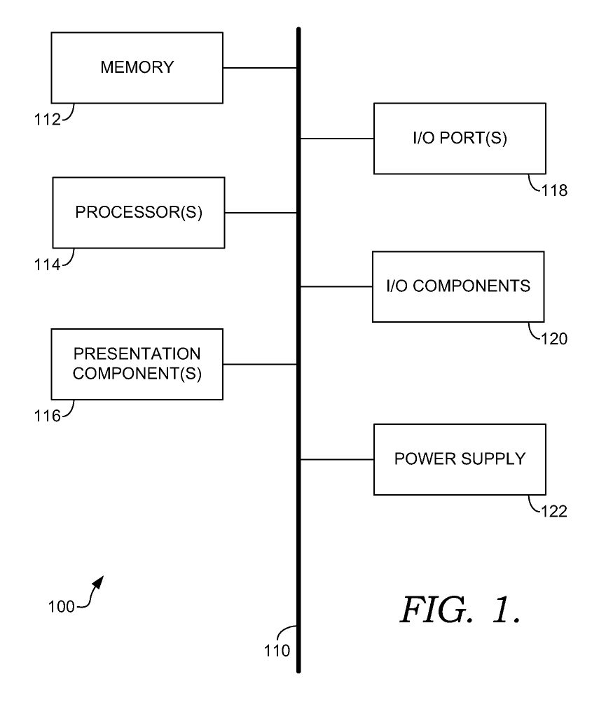

An exemplary computing environment suitable for use in implementing embodiments of the present invention is described below in order to provide a general context for various aspects of the present invention. Referring to FIG. 1, such an exemplary computing environment is shown and designated generally as computing device 100. The computing device 100 is but one example of a suitable computing environment and is not intended to suggest any limitation as to the scope of use or functionality of embodiments of the invention. Neither should the computing device 100 be interpreted as having any dependency or requirement relating to any one or combination of components illustrated.

Embodiments of the invention may be described in the general context of computer code or machine-useable instructions, including computer-executable instructions such as program modules, being executed by a computer or other machine, such as a personal data assistant or other handheld device. Generally, program modules, including routines, programs, objects, components, data structures, etc., refer to code that performs particular tasks or implements particular abstract data types. Embodiments of the invention may be practiced in a variety of system configurations, including hand-held devices, consumer electronics, general-purpose computers, more specialty computing devices, and the like. Embodiments of the invention may also be practiced in distributed computing environments where tasks are performed by remote-processing devices that are linked through a communications network.

With continued reference to FIG. 1, the computing device 100 includes a bus 110 that directly or indirectly couples the following devices: a memory 112, one or more processors 114, one or more presentation components 116, one or more input/output (I/O) ports 118, I/O components 120, and an illustrative power supply 122. The bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Additionally, many processors have memory. The inventors hereof recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computer” or “computing device.”

The computing device 100 typically includes a variety of computer-readable media. Computer-readable media may be any available media that is accessible by the computing device 100 and includes both volatile and nonvolatile media, removable and non-removable media. Computer-readable media comprises computer storage media and communication media; computer storage media excludes signals per se. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. Communication media, on the other hand, embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The memory 112 includes computer-storage media in the form of volatile and/or nonvolatile memory. The memory may be removable, non-removable, or a combination thereof. Exemplary hardware devices include solid-state memory, hard drives, optical-disc drives, and the like. The computing device 100 includes one or more processors that read data from various entities such as the memory 112 or the I/O components 120. The presentation component(s) 116 present data indications to a user or other device. Exemplary presentation components include a display device, speaker, printing component, vibrating component, and the like.

The I/O ports 118 allow the computing device 100 to be logically coupled to other devices including the I/O components 120, some of which may be built in. Illustrative components include a microphone, a camera, joystick, game pad, satellite dish, scanner, printer, wireless device, etc.

Aspects of the subject matter described herein may be described in the general context of computer-executable instructions, such as program modules, being executed by a mobile device. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

Furthermore, although the term “server” is often used herein, it will be recognized that this term may also encompass a search engine, a Web browser, a set of one or more processes distributed on one or more computers, one or more stand-alone storage devices, a set of one or more other computing or storage devices, a combination of one or more of the above, and the like.

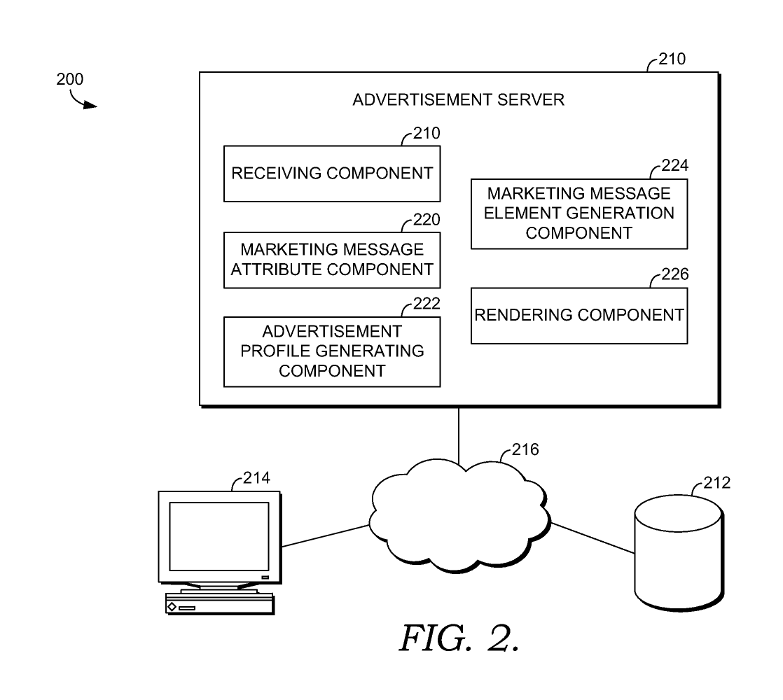

With this as a background and turning to FIG. 2, an exemplary system 200 is depicted for use in generating and/or updating an advertisement-targeting profile, generating and/or updating predefined marketing-message elements, and selecting and/or modifying marketing messages based on the advertisement-targeting profile and/or the predefined marketing-message elements. The system 200 is merely an example of one suitable system environment and is not intended to suggest any limitation as to the scope of use or functionality of embodiments of the present invention. Neither should the system 200 be interpreted as having any dependency or requirement related to any single module/component or combination of modules/components illustrated therein.

The system 200 includes an advertisement server 210, a data store 212, and an end-user computing device 214 all in communication with one another via a network 216. The network 216 may include, without limitation, one or more local area networks (LANs) and/or wide area networks (WANs). Such networking environments are commonplace in offices, enterprise-wide computer networks, intranets and the Internet. Accordingly, the network 216 is not further described herein.

In some embodiments, one or more of the illustrated components/modules may be implemented as stand-alone applications. In other embodiments, one or more of the illustrated components/modules may be integrated directly into, for example, the operating system of the end-user computing device 214 or the advertisement server 210. The components/modules illustrated in FIG. 2 are exemplary in nature and in number and should not be construed as limiting. Any number of components/modules may be employed to achieve the desired functionality within the scope of embodiments hereof. Further, components/modules may be located on any number of servers. By way of example only, the advertisement server 210 might reside on a server, a cluster of servers, or a computing device remote from one or more of the remaining components.

It should be understood that this and other arrangements described herein are set forth only as examples. Other arrangements and elements (e.g., machines, interfaces, functions, orders, and groupings of functions) can be used in addition to or instead of those shown, and some elements may be omitted altogether. Further, many of the elements described herein are functional entities that may be implemented as discrete or distributed components or in conjunction with other components/modules, and in any suitable combination and location. Various functions described herein as being performed by one or more entities may be carried out by hardware, firmware, and/or software. For instance, various functions may be carried out by a processor executing instructions stored in memory.

The data store 212 is configured to store information for use by, for example, the advertisement server 210. Further, the information stored in association with the data store 212 is configured to be searchable for one or more items of information stored in association therewith. The information stored in association with the data store 212 may comprise general information used by the advertisement server 210. For example, the data store 212 may store information concerning recorded search behavior of users in general, and a log of a particular user's tracked interactions with the advertisement server 210. The search behavior may include Web pages visited, duration of time spent on any one Web page, links selected on Web pages, and the like. The search behavior may also include search behavior directed toward marketing messages presented on the Web pages. For the purposes of this application, the term “marketing message” may be used interchangeably with the term “advertisement.” Search behavior with respect to marketing messages may include selecting (e.g., “clicking on”) marketing messages, hovering over marketing messages, and, where the information is available, whether the user completed a purchase after selecting a marketing message. The Web pages may include search engine pages such as an initial search engine page and/or a search engine results page. The Web pages may also include content Web pages originating from a browser search using a uniform resource locator (URL), a selection of a search result, a selection of a hyperlink, and the like.

Information stored in association with the data store 212 may further include one or more advertisement-targeting profiles associated with a user group or a particular user and one or more predefined marketing-message elements. Further, the data store 212 may store cached marketing messages provided by advertisers or third parties. The cached marketing messages may include template marketing messages that can be dynamically modified using the predefined marketing-message elements. The cached marketing messages may also include marketing messages categorized by user preferences. For example, marketing messages may be categorized based on shipping incentives, sale incentives, price point, type of product or service, brand, quality, and the like. The data store 212 may also store attributes associated with marketing messages. These aspects will be explored in greater depth below.

The content and volume of such information in the data store 212 are not intended to limit the scope of embodiments of the present invention in any way. Further, though illustrated as a single, independent component, the data store 212 may, in fact, be a plurality of storage devices, for instance, a database cluster, portions of which may reside on the advertisement server 210, the end-user computing device 214, and/or any combination thereof.

The end-user computing device 214 shown in FIG. 2 may be any type of computing device, such as, for example, the computing device 100 described above with reference to FIG. 1. By way of example only and not limitation, the end-user computing device 214 may be a personal computer, desktop computer, laptop computer, handheld device, mobile handset, consumer electronic device, or the like. It should be noted, however, that embodiments are not limited to implementation on such computing devices, but may be implemented on any of a variety of different types of computing devices within the scope of embodiments hereof. The end-user computing device 214 may receive inputs through a variety of means such as voice, touch, and/or gestures. As shown, the end-user computing device 214 includes a display screen. The display screen is configured to present information, including Web pages and marketing messages, to the user of the end-user computing device 214.

The system 200 is merely exemplary. While the advertisement server 210 is illustrated as a single unit, it will be appreciated that the advertisement server 210 is scalable. For example, the advertisement server 210 may in actuality include a plurality of computing devices in communication with one another. Moreover, the data store 212, or portions thereof, may be included within, for instance, the advertisement server 210 as a computer-storage medium. The single unit depictions are meant for clarity, not to limit the scope of embodiments in any form.

As shown in FIG. 2, the advertisement server 210 comprises a receiving component 218, a marketing message attribute component 220, an advertisement profile generating component 222, a marketing-message element generation component 224, and a rendering component 226. In some embodiments, one or more of the components 218, 220, 222, 224, and 226 may be implemented as stand-alone applications. In other embodiments, one or more of the components 218, 220, 222, 224, and 226 may be integrated directly into the operating system of a computing device such as the computing device 100 of FIG. 1. It will be understood that the components 218, 220, 222, 224, and 226 illustrated in FIG. 2 are exemplary in nature and in number and should not be construed as limiting. Any number of components may be employed to achieve the desired functionality within the scope of embodiments hereof.

The receiving component 218 is configured to receive indications that a user is interacting with marketing messages. Interactions may include hovering over a marketing message, clicking or selecting a marketing message, and, where the information is available, determining whether the user completed a purchase after selecting a marketing message. As mentioned above, the marketing messages may be presented on a search engine page, or on a content Web page. The marketing messages may encompass multiple categories of products and/or services or may be directed to a single category of products and/or services. The receiving component 218 is further configured to receive indications of the time in which the interactions occurred. This may include time of day, time of week, time of month, or time of year. The receiving component 218 is also configured to receive requests from, for example, advertisers or third parties to present a marketing message on a Web page. Additionally, the receiving component 218 is configured to receive marketing messages from advertisers or third parties.

The marketing message attribute component 220 is configured to determine attributes that are associated with a marketing message that the user has interacted with, as well as attributes that are shared across multiple marketing messages that the user interacted with. Along these lines, the marketing message attribute component 220 may be equipped with logic to identify any or all attributes that are possessed by a particular marketing message upon that marketing message being targeted by a user interaction. The attributes may be embedded as metadata within each marketing message. As well, attributes associated with a particular marketing message may have previously been communicated by an advertiser or third party to the advertisement server 210.

The types of attributes associated with marketing messages are myriad. They include the type of product or service associated with the marketing message, a brand name, a price point, shipping information, sales information, promotion information, reward-point information, ratings information such as consumer ratings information, how new the product or service is, whether the product or service is a luxury item or a value item, the origin of the product or service, and the like. These are just a few examples of the types of attributes associated with marketing messages. Any attribute that helps to define or characterize the content of the marketing message is considered within the scope of the invention.

A subset of the attributes enumerated above includes incentive attributes. As used herein, the phrase “incentive attributes” is not meant to be limiting, but broadly refers to any attributes of a marketing message that appeal to a user regardless of the type or brand of product or service being advertised. Incentive attributes may be contrasted with the general properties associated with the product or service being advertised. These general properties may include the subject matter (e.g., the brand or identity of the product or service being advertised) of the marketing message along with keywords describing the subject matter. Incentives attributes, on the other hand, may be independent of the subject matter of the marketing message. Incentive attributes may include shipping incentives, sales incentives, reward point incentives, promotional incentives, quality incentives, place of origin of the product or service (e.g., “Made in the U.S.A.), and the like. Again, these are just a few examples of the type of intangible attributes associated with marketing messages. Although the incentive attributes do not typically include product type and brand as described above, it should be appreciated and understood that various forms and styles of incentive attributes may be monitored and recorded and that embodiments of the present invention are not limited to the specific examples described herein. For example, incentive attributes may comprise any aspects of an advertisement that act to hook a user into responding to the marketing message.

As mentioned above, the marketing message attribute component 220 is configured to determine if attributes that the user has interacted with are shared amongst a predetermined number of the marketing messages. For instance, a user may consistently respond over a period of time to sale incentives included within a variety of marketing messages. The marketing message attribute component 220 is also configured to determine if the attributes that the user has interacted with are associated with a specified category of goods or services. By way of illustrative example, a user may respond to attributes such as “Just Released,” or “The Latest” when it comes to electronics marketing messages, but may respond to attributes such as “Highly Rated,” or “Reliable” when it comes to household appliances marketing messages. Attributes that are shared across a predetermined number of marketing messages give a good indication of the qualities that a user favors when deciding to interact with marketing messages. The marketing message attribute component 220 is configured to categorize shared attributes by category of product or service, by time period in which the interaction occurred, by user, and the like. Any and all such aspects are contemplated as being within the scope of the invention.

The advertisement profile generating component 222 is configured to generate and/or update an advertisement-targeting profile for a user or group of users. The advertisement profile generating component 222 utilizes the attributes associated with a marketing message that the user has interacted with as well as attributes that are shared across the marketing messages to build or update user preferences. For instance, if a portion of the shared attributes is directed to shipping incentives, then a user preference regarding shipping incentives is constructed. Similarly, if a portion of the shared attributes is directed to sales offers, then a user preference regarding sales incentives is constructed. The advertisement profile generating component 222 may rank the preferences based on, for example, how frequently and/or recently the user responds to marketing messages with attributes directed to a particular preference. Thus, a preference for shipping incentives may be ranked higher than a preference for sales incentives if the user responds more frequently and/or recently to marketing messages with shipping incentives than marketing messages with sales incentives. Further, within a particular preference (e.g., a shipping preference), preferences may be sorted and ranked based on frequency of interaction. For instance, within a shipping preference, a user may respond more, or more recently, to shipping preferences related to “free shipping,” as compared to shipping preferences related to “next-day shipping;” the “free shipping” preference would then be ranked higher than the “next-day shipping” preference. The advertisement profile generating component 222 is further configured to classify preferences by category of product or service or by other types of attributes such as brand, time period in which the interaction occurred, and the like. The advertisement-targeting profile is stored in association with the data store 212.

The advertisement profile generating component 222 is also configured to modify the advertisement-targeting profile of the user based on the preferences of similarly-situated users. Similarly-situated users comprise users in the same geographic area as the user-in-question, users that share similar demographic traits (e.g., age, ethnicity, gender, etc.) with the user-in-question, and/or users in the same economic class or within the same social network as the user-in-question. In this case, the advertisement-targeting profile represents the preferences of a group of similarly-situated users.

The marketing-message element generation component 224 is configured to generate predefined marketing-message elements using the advertisement-targeting profile. The predefined marketing-message elements are targeted toward the user's or users' preferences. The elements may later be used in marketing messages that are presented on Web pages. A certain number of marketing-message elements may be generated for each preference. For example, if a user has a preference for shipping incentives, marketing-message elements may include “Free Shipping,” and “Next-Day Shipping.” Likewise, if a user has a preference for sales incentives, marketing-message elements may include “10% Off,” or “Buy One Get One Free.” The predefined marketing-message elements may be categorized by user, product or service category, attribute type (e.g., price point, brand, origin of the product or service, quality, etc.), or user group. Further, the predefined marketing-message elements may be limited in number and may satisfy more than one marketing message. In another aspect, the marketing-message element generation component 224 is configured to access a data store (such as, for example, the data store 212) and select from a predetermined listing of marketing-message elements.

The rendering component 226 is configured, in one aspect, to select marketing messages based on the advertisement-targeting profile. The marketing messages may be selected from cached marketing messages, or the marketing message may be retrieved from an advertiser or third-party. In one aspect of the invention, it is contemplated that information concerning user preferences may be provided to advertisers or third-parties. This information can be used to pre-generate a set of marketing messages targeting those preferences.

The rendering component 226 is further configured to utilize the predefined marketing-message elements in combination with the advertisement-targeting profile to customize or modify in real-time template marketing messages provided by, for example, an advertiser or third party. With respect to this aspect, a marketing message comprises a dynamic template with one or more placeholders; the template is able to receive predefined marketing-message elements in the placeholders (e.g., using an embedded macro in the template). In one aspect, the marketing-message element is a basic text overly that is placed on a blank region of the template. In another aspect, the marketing-message element is seamlessly integrated into the template. The rendering component 226 may also combine two or more predefined marketing-message elements into a single marketing message. For instance, an advertisement-targeting profile may indicate that a user or user group has preferences for both shipping incentives and sale incentives. The rendering component 226 may select or extract a predefined marketing-message element for each preference and insert each into a single marketing message. The rendering component 226 is additionally configured to present the marketing message(s) on a Web page such as a search engine page or a content Web page.

In another aspect, the rendering component 226 is configured to communicate predefined marketing-message elements to advertisers and/or third parties. The advertisers and/or third parties then insert the predefined marketing-message elements into template marketing messages. The modified marketing messages are then communicated to the advertisement server 210 where they are presented on one or more Web pages.

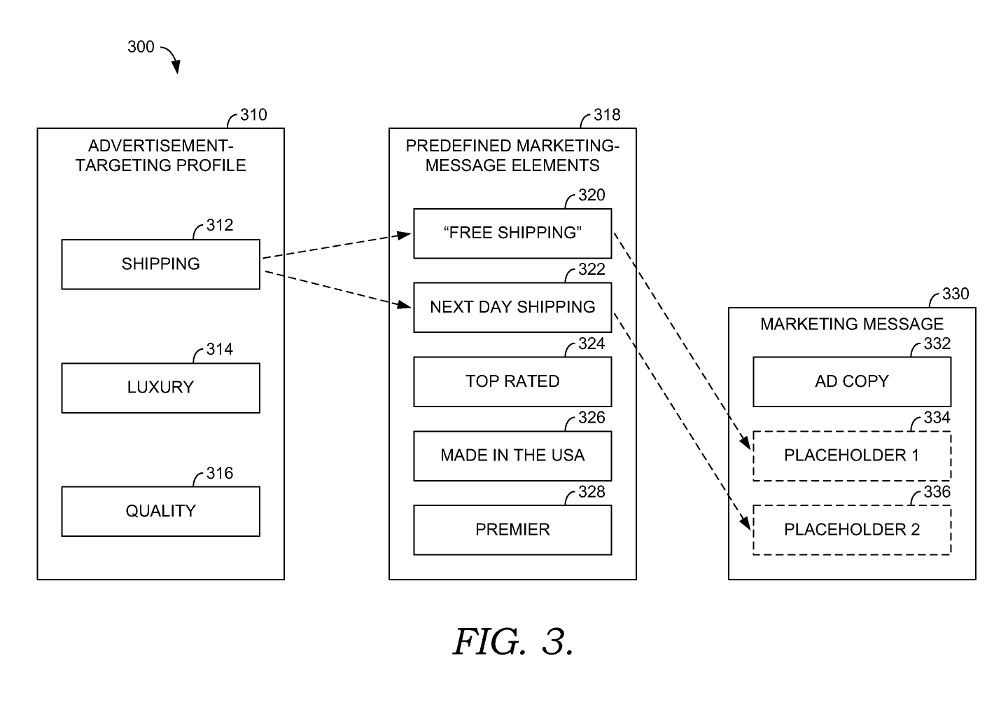

Turning now to FIG. 3, FIG. 3 illustrates the use of an advertisement-targeting profile in combination with predefined marketing-message elements to create a customized marketing message. FIG. 3 includes an advertisement-targeting profile 310, predefined marketing-message elements 318, and a marketing message 330. The advertisement-targeting profile 310, the predefined marketing-message elements 318, and, optionally, the marketing message 330 may be stored in association with a data store such as the data store 212 of FIG. 2.

The advertisement-targeting profile 310 includes preferences associated with a user or with a user group. For instance, it may have been determined by monitoring user interactions with marketing messages on Web pages that a user has a preference for shipping incentives 312, luxury attributes 314, and quality attributes 316. The preferences may be ranked based on frequency of interactions and/or on how recent the interactions occurred. Further, the preferences may be categorized by type of product or service, user group, and/or other attributes.

The predefined marketing-message elements 318 are generated based on the preferences in the advertisement-targeting profile 310. By way of example, the preference of “Shipping” 312 may be associated with the predefined marketing messages “Free Shipping” 320 and “Next Day Shipping” 322. The preference of “Luxury” 314 may be associated with the predefined marketing message “Premier” 328. Likewise, the preference of “Quality” 316 is associated with the predefined marketing messages “Made in the U.S.A.” 326 and “Top Rated” 324. The predefined marketing-message elements 318 may be categorized by type of product or service or may be applicable to any product or service. The predefined marketing-message elements 318 may also be categorized based on, for example, user groups, or other attributes.

The marketing message 330 is a template marketing message that includes advertisement copy 332, a first placeholder 334, and a second placeholder 336. The advertisement copy 332 is provided by the advertiser and may be fixed in nature. The advertisement copy 332 identifies the product or service and other attributes that are the subject of the marketing message 330. The placeholders 334 and 336 are configured to receive one or more of the predefined marketing-message elements 318.

By way of illustrative example, an advertiser or third party may request an advertisement server such as the advertisement server 210 of FIG. 2 to present the marketing message 330 on a Web page being visited by a user. The advertisement server accesses the user's advertisement-targeting profile 310 to identify the user's preferences. The advertisement server selects the shipping preference 312. This may be, for example, because the shipping preference 312 is highly ranked or may be because the marketing message 330 is directed to a particular category to which the shipping preference 312 is applicable. In another example, the shipping preference 312 may be selected based on time of day, week, month or year (e.g., the user likes to take advantage of shipping incentives during the holiday season). The advertisement server then identifies predefined marketing-message elements related to the shipping preference 312; these include “Free Shipping” 320 and “Next Day Shipping” 322. The predefined marketing-message elements 320 and 322 are then dynamically inserted into the first placeholder 334 and the second placeholder 336 to create a customized marketing message designed to increase user responsiveness.

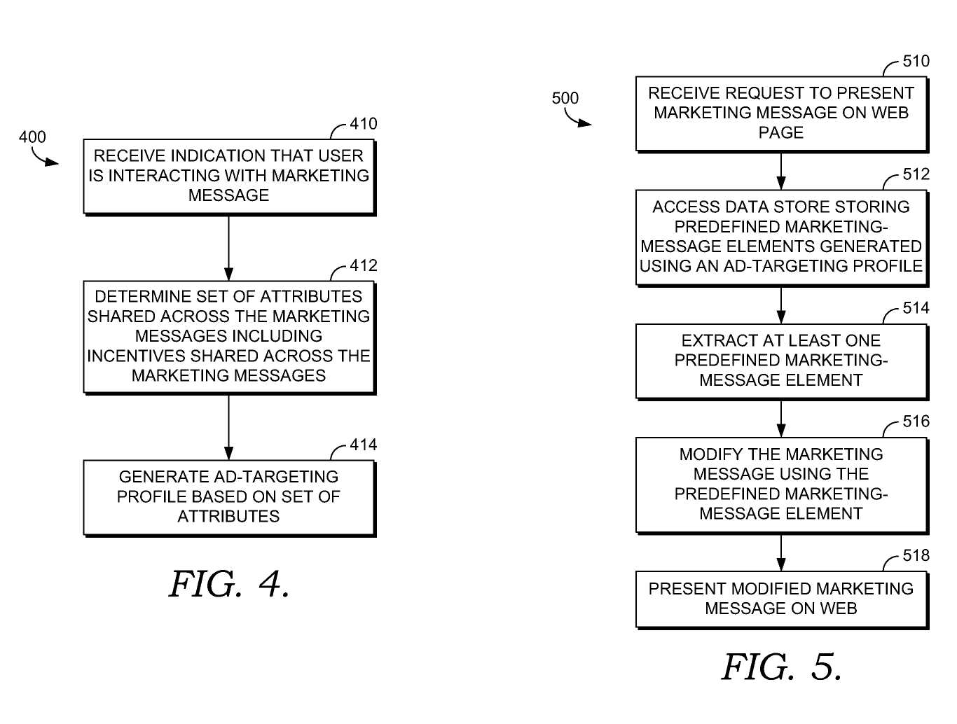

FIG. 4 depicts a flow diagram illustrating an exemplary method 400 of generating an advertisement-targeting profile useful for increasing user responsiveness to marketing messages. At a step 410, an indication that a user is interacting with a marketing message on one or more Web pages is received by a receiving component such as the receiving component 218 of FIG. 2. The interactions may include hovering over a marketing message, selecting a marketing message, and, where the information is available, whether the user completed a purchase after selecting the marketing message. The marketing message may be directed to multiple different types of products or services and may include a variety of different attributes such as the type of product or service, brand name, price point, shipping information, sales information, promotion information, reward-point information, ratings information, and the like.

At a step 412, a set of attributes shared across the marketing messages is determined by, for example, a marketing message attribute component such as the marketing message attribute component 220 of FIG. 2. The set of attributes may include a subset of incentive attributes such as shipping incentives, sales incentives, promotion incentives, reward-point incentives, and the like.

At a step 414, the advertisement-targeting profile for the user is generated and/or updated based on the attributes shared across the different marketing messages. This may be done be an advertisement profile generating component such as the advertisement profile generating component 222 of FIG. 2. The advertisement-targeting profile comprises user preferences related to the set of attributes. The preferences may be categorized according to product type or service type and may be ranked by frequency of interactions. The advertisement-targeting profile is stored in association with a data store such as the data store 212 of FIG. 2. Further, the advertisement-targeting profile may be modified based on preferences of similarly-situated users. Examples of similarly-situated users include users who share demographic traits with the user, as well as users within the same online social network as the user or within the same geographic area as the user.

The advertisement-targeting profile is used to, for example, select marketing messages that contain elements (e.g., advertisement copy) directed to the user's preferences. These marketing messages may be cached marketing messages or the marketing messages may be provided by advertisers or third parties. The advertisement-targeting profile is also used to generate one or more predefined marketing-message elements; each of the predefined marketing-message elements is directed to one or more of the identified user preferences. These elements are utilized to customize or modify template marketing messages so the marketing messages are more appealing to the user.

Turning to FIG. 5, FIG. 5 depicts a flow diagram illustrating an exemplary method 500 for modifying a marketing message using predefined marketing-message elements. At a step 510, a request to present a marketing message on a Web page such as a search engine page or a content Web page is received from an advertiser or a third party. The marketing message may comprise a dynamic template marketing message with one or more placeholders.

At a step 512, a data store is accessed. The data store stores predefined marketing-message elements that were generated using an advertisement-targeting profile associated with a user. The predefined marketing-message elements may be categorized by user group, by attribute, and/or by category of the product or service and may be ranked by user popularity (as indicated by frequency of interaction) within each category. For instance, marketing-message elements may be categorized into a shipping category, a sales category, a luxury category, a quality category, and the like. In another example, marketing-message elements may be categorized into an electronics category, a household appliances category, an auto category, a personal grooming category, and the like. Any and all such aspects are contemplated as being within the scope of the invention.

At a step 514, a predefined marketing-message element(s) is extracted. In one aspect, any of the predefined marketing-message elements may be extracted. In another aspect, top-ranked marketing-message elements are extracted. In yet another aspect, the extraction of a particular marketing-message element may be based on, for example, attributes of the marketing message indicating that the marketing message belongs to a particular category of product or service. Still further, marketing-message elements from different categories may be extracted. Any and all such aspects are contemplated as being within the scope of the invention.

At a step 516, the marketing message is modified using the extracted predefined marketing-message element. The marketing message may be modified by the insertion of the predefined marketing-message elements into the placeholders. The modification of the marketing message may be done by a rendering component such as the rendering component 226 of FIG. 2, or the modification may be done by the advertiser or third party. This process may occur dynamically (e.g., at the time the request from the advertiser is received). The predefined marketing-message element may be inserted into the template marketing message so that the text associated with the marketing-message element overlays the placeholder(s). As well, the predefined marketing-message element may be seamlessly integrated into the template marketing message. The modified marketing message is subsequently presented on the Web page at a step 518.

As mentioned, the predefined marketing-message elements are generated using the advertisement-targeting profile. The method of generating the predefined marketing-message elements comprises receiving an indication that the user is interacting with a plurality of marketing messages on one or more Web pages over a period of time. Each marketing message comprises a plurality of attributes. Attributes that are shared across the marketing messages are determined. The shared attributes include, in part, incentive attributes such as sales incentives, shipping incentives, reward incentives, promotion incentives, and the like. An advertisement-targeting profile for the user is generated which comprises user preferences related to the shared attributes. For instance, preferences may include shipping preferences, quality preferences, brand preference, product or service type preferences, origin preferences, and the like. The preferences may be ranked by frequency of interactions. As well, the preferences may be categorized by user group, time period in which the interactions occurred, or by attribute such as by type of product or service, and the like. The advertisement-targeting profile is then used to generate predefined marketing-message elements for each of the preferences in the profile.

The present invention has been described in relation to particular embodiments, which are intended in all respects to be illustrative rather than restrictive. Alternative embodiments will become apparent to those of ordinary skill in the art to which the present invention pertains without departing from its scope.

What is claimed is:

1. One or more computer-storage media storing computer-useable instructions that, when used by one or more computing devices, cause the one or more computing devices to perform a method of generating an advertisement-targeting profile useful for increasing user responsiveness to marketing messages, the method comprising:
receiving an indication that a user is interacting with a marketing message on one or more Web pages, the marketing message comprising a plurality of attributes;
determining, using the one or more computing devices, a first set of attributes of the plurality of attributes that is shared across a plurality of marketing messages, the first set of attributes comprising, in part, a first subset of incentives; and
updating an advertisement-targeting profile for the user based on, in part, the first set of attributes, the advertisement-targeting profile comprising one or more user preferences related to the first set of attributes.

2. The media of claim 1, wherein interacting with the marketing message on the one or more Web pages comprises at least one of hovering over the marketing message or selecting the marketing message.

3. The media of claim 1, wherein the marketing message is associated with a plurality of different product categories or a plurality of different service categories.

4. The media of claim 1, wherein the marketing message is associated with a single product category or a single service category.

5. The media of claim 1, wherein the plurality of attributes comprises at least one of the following attributes: a type of product, a type of service, a brand name, a price point, shipping information, sales information, promotion information, reward-point information, or ratings information.

6. The media of claim 1, wherein the subset of incentives includes one or more of shipping incentives, sales incentives, reward-point incentives, or promotion incentives.

7. The media of claim 1, further comprising storing the advertisement-targeting profile in association with a data store.

8. The media of claim 1, further comprising modifying the advertisement-targeting profile for the user based on preferences of similarly-situated users, wherein similarly-situated users comprise at least one of: users in the same geographic area as the user, users that have similar demographic traits as the user, users within the same economic class as the user, or users within the user's online social network.

9. The media of claim 1, further comprising using the advertisement-targeting profile of the user to select one or more marketing messages to present on one or more Web pages.

10. The media of claim 1, further comprising:
using the advertisement-targeting profile to modify one or more template marketing messages; and
presenting the modified template marketing message on one or more Web pages.

11. A computerized method carried out by an advertisement server for modifying a marketing message using predefined marketing-message elements, the method comprising:
receiving a request from an advertiser or third party to present a marketing message on one or more Web pages;
accessing a data store that stores one or more predefined marketing-message elements that were generated using an advertisement-targeting profile associated with a user;
extracting at least one predefined marketing-message element;
modifying the marketing message using the at least one predefined marketing-message element; and
presenting the modified marketing message on the one or more Web pages.

12. The method of claim 11, wherein the one or more predefined marketing-message elements are categorized by one of a product category or a service category.

13. The method of claim 11, wherein the one or more predefined marketing-message elements are ranked based on user popularity.

14. The method of claim of claim 11, wherein generating the predefined marketing-message elements using the advertisement-targeting profile comprises:
receiving an indication that the user is interacting with a plurality of marketing messages on one or more Web pages over a period of time, each marketing message of the plurality of marketing messages comprising a plurality of attributes;
determining a set of attributes of the plurality of attributes that is shared across the plurality of marketing messages, the set of attributes comprising, in part, a subset of incentives;
generating the advertisement-targeting profile for the user based on the set of attributes, the advertisement-targeting profile comprising one or more user preferences related to the set of attributes; and
using the advertisement-targeting profile, generating the one or more predefined marketing-message elements for each preference of the one or more user preferences.

15. The method of claim 11, wherein the marketing message is a template marketing message with one or more placeholders, and wherein the marketing message is modified by inserting the at least one predefined marketing-message element into the one or more placeholders.

16. The method of claim 15, wherein the at least one predefined marketing-message element overlays the one or more placeholders.

17. The method of claim 15, wherein the at least one predefined marketing-message element is integrated into the template.

18. A system for modifying one or more marketing messages using an advertisement-targeting profile, the system comprising:
a data store storing a set of predefined marketing-message elements, each predefined marketing-message element of the set of predefined marketing-message elements associated with an identified user preference in an advertisement-targeting profile stored in association with the data store; and
an advertisement server having one or more computer storage media coupled with the data store, wherein the advertisement server: receives a request from an advertiser to present a marketing message on a Web page; accesses the set of predefined marketing-message elements stored in association with the data store; extracts at least one predefined marketing-message element from the set of predefined marketing-message elements; and modifies the marketing message using the at least one predefined marketing-message element.

19. The system of claim 18, wherein the Web page represents a search engine page.

20. The system of claim 18, wherein the Web page represents a content page.
